(19) United States
(12) Patent Application Publication
(10) Pub. No.: US 2016/0362173 A1
(43) Pub. Date: Dec. 15, 2016

(54) Peripheral Attachment System for Drones

(71) Applicants: Daniel R. Marion, San Diego, CA (US); Ezon James, San Diego, CA (US)

(72) Inventors: Daniel R. Marion, San Diego, CA (US); Ezon James, San Diego, CA (US)

(21) Appl. No.: 14/738,640

(22) Filed: Jun. 12, 2015

(51) Int. Cl. B64C 7/00; G01S 15/96; A01K 91/00; B64C 39/02

(52) U.S. Cl. CPC B64C 7/00; B64C 39/024; G01S 15/96; A01K 91/00; B64C 2201/126; B64C 2201/024; B64C 2201/108

(57) ABSTRACT

A peripheral mounting system for a drone has a cylindrical receptacle configured to be mounted to the bottom of a drone, an attachment for engaging with the receptacle, the attachment having a dome-shaped capsule configured to retain a peripheral, the edge of the capsule defining a base and a fastener at the base of the capsule, for sealingly engaging with the receptacle to form a watertight seal. The receptacle may be a threaded collar affixed to the bottom of the drone, wherein the fastener is threaded into the receptacle. In an embodiment, the peripheral is a sonar unit to locate fish and a wireless unit is configured to transmit fish location to a remote user. In another embodiment the peripheral comprises a grip configured to carry a fishing line to a remote location.

### FIELD OF THE INVENTION

This invention relates to a system for attachment of peripherals to a drone or radio-controlled vehicle.

### BACKGROUND OF THE INVENTION

Drones are becoming commonplace for their ability to deliver things and make observations in remote or hostile environments. Drones are used for remote sensing, carrying sensors into areas that are difficult or dangerous for a human to enter. Drones also carry payloads into remote locations, and can deliver or pick up remotely, without the presence of a human being.

A single drone may be used for a number of different purposes, depending on the tools or sensors that are attached thereto. Therefore, it is beneficial to have a means of securing and interchanging the peripherals attached to a drone, so a drone may serve a number of different purposes.

### SUMMARY OF THE INVENTION

The present invention overcomes these and other deficiencies of the prior art by providing a means of securely and interchangeably mounting peripherals to drones to permit the drone to be used with a variety of peripherals to complete a variety of tasks.

A peripheral mounting system for a drone has a cylindrical receptacle configured to be mounted to the bottom of a drone, an attachment for engaging with the receptacle, the attachment having a dome-shaped capsule configured to retain a peripheral, the edge of the capsule defining a base and a fastener at the base of the capsule, for sealingly engaging with the receptacle to form a watertight seal.

In an embodiment the wires from a peripheral pass through an opening in the capsule to protrude from the capsule, wherein the wires and configured to connect with wires from the drone, and wherein the opening in the capsule is sealed with a sealant. Further, the receptacle may comprise a threaded bolt protruding from the bottom of the drone, wherein the fastener is threaded onto the receptacle.

The receptacle may be a threaded collar affixed to the bottom of the drone, wherein the fastener is threaded into the receptacle. The system may also have a gasket between the receptacle and the fastener. In an embodiment, the peripheral is a sonar unit to locate fish and a wireless unit is configured to transmit fish location to a remote user. In another embodiment the peripheral comprises a grip configured to carry a fishing line to a remote location and an actuator for actuating the grip to release the line at the remote location.

An access cap for a drone has a dome-shaped cap configured to fit within a drone access port, wherein the cap comprises a hollow dome made of a single piece of plastic, an opening of the dome and a port-engagement surface around the edge of the dome, and a gasket configured to fit between the drone access opening and the cap, and is configured to form a waterproof seal therebetween.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is top perspective view of the drone, according to one embodiment of the invention;

FIG. 2 is bottom perspective view of the drone with peripheral attached, according to one embodiment of the invention;

FIG. 3 is bottom perspective view of the drone without peripheral attached, according to one embodiment of the invention;

FIG. 4 is side elevation view of the drone, according to one embodiment of the invention;

FIG. 5 is exploded side elevation view of the drone, according to one embodiment of the invention; and

FIG. 6 is a detail perspective view of the pitch pocket, according to an embodiment of the invention.

### DETAILED DESCRIPTION OF PREFERRED EMBODIMENTS

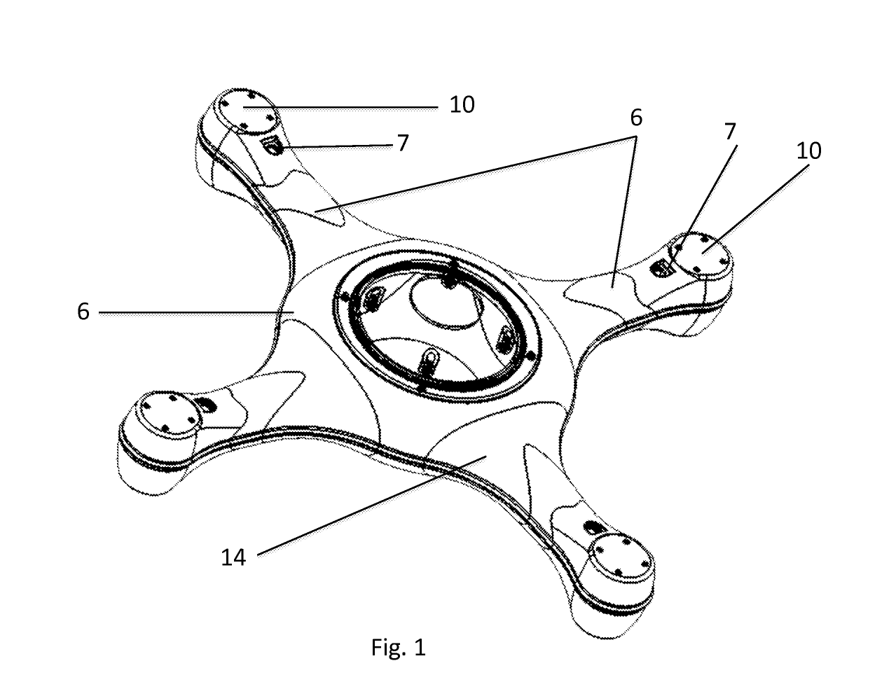

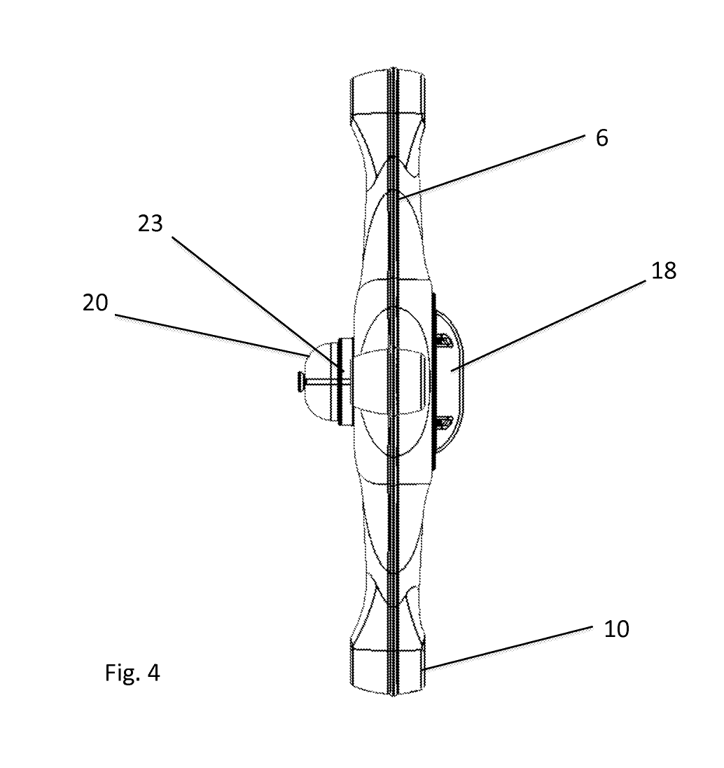

With reference to FIGS. 1 to 5, the drone 2 comprises a quadcopter or other remote control unmanned vehicle. The quadcopter typically has radio-frequency signals for controlling the drone and for transmitting data, including photographs or other data, back to the control handset or a computer. In the embodiment of a quadcopter, the drone 2 has four motorized rotors 6 attached to arms 10 to provide lift. In one embodiment, on the underside of the rotors are landing pads 8. The drone has a weather-resistant body 14 formed of an upper half 12 and a lower half 13 molded from plastic and fastened together such as by screws. The body 14 has a central access port 16 through which the electronics (not shown) within the drone 2 may be accessed. In an embodiment, the central access port 16 has a dome-shaped cover 18 that engages with the port 16 to form a water-tight closure by snapping in, having a friction fit or screwing in. A rubber or plastic gasket 19 may be present between the cover 18 and the port 16. The dome-shaped cover 18 provides greater space for the interior of the drone 2 and sheds water easily due to its dome shape. Also, should the drone 2 flip in the water, the cover 18 prevents the entry of water. As removing and replacing the cover 18 may admit liquid to the interior, the electronics and wired connections therein are preferably waterproofed, either by being coated in plastic or by a water tray for diverting water from the electronics. On the lower half 13 of the body is a receptacle 23 for holding an attachment 20, and in an embodiment, the landing pads 8 are longer than the protrusion of the attachment 20, enough to prevent the attachment from touching the ground and being scratched or breaking when the landing pads 8 are supporting the body 14.

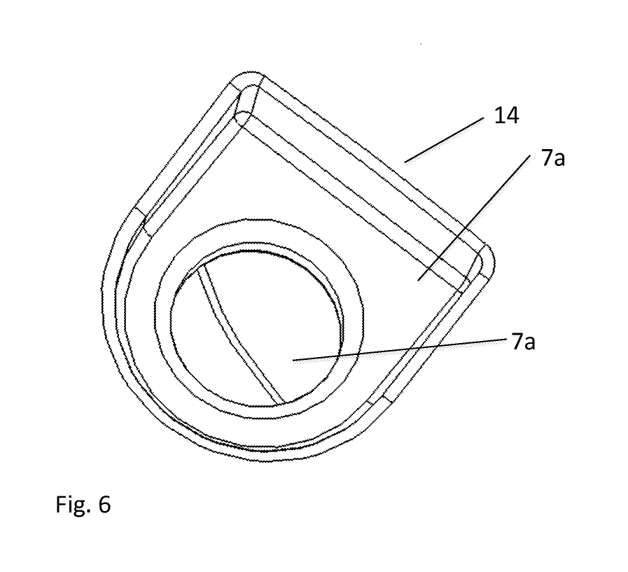

In an embodiment, with reference to FIG. 6, where wires (not shown) pass through the body 14, the wiring passes through a pitch pocket or step trough 7a that is recessed from the body 14 surface, wherein the wire passes through an opening 7b in the trough 7a into the body, and the trough 7a may be filled with a self-leveling sealant such as silicone, which forms a watertight seal between the trough 7a and the wiring, and forms a flush or smooth line with the surface of the body 14. The wires within the opening 7b form gaps that are too small for the sealant to flow through, so the sealant dries within the trough 7a and seals around the wires (not shown).

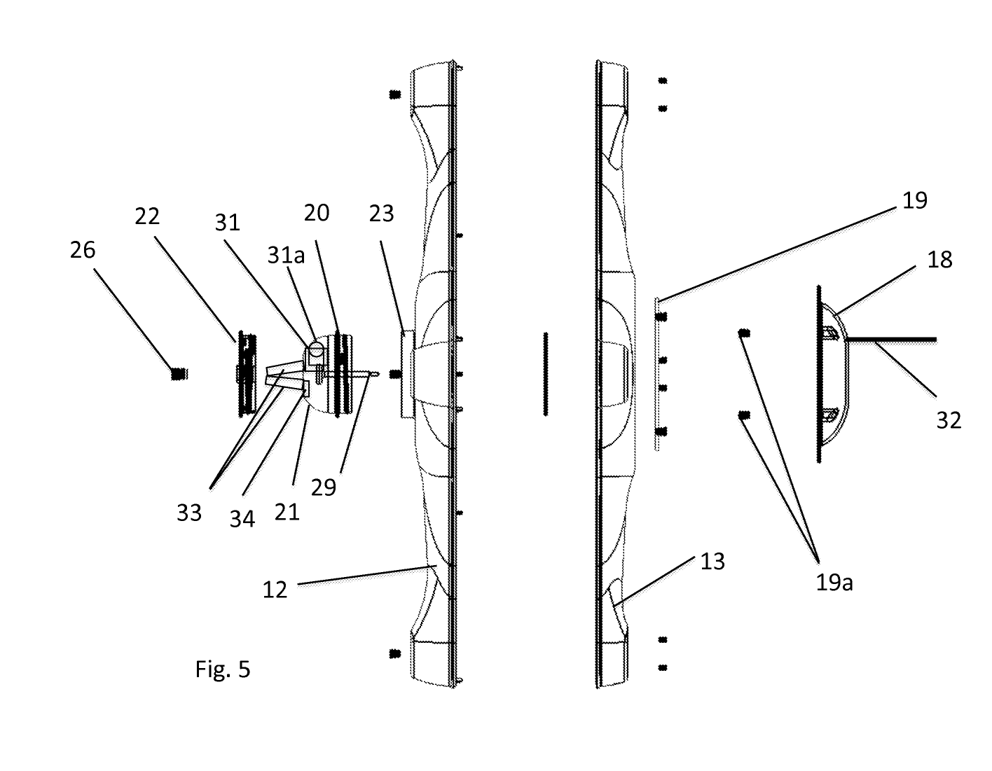

With reference to FIG. 5, the cover 18 is shown. In an embodiment, the cover 18 has a plurality of reinforcing fastener apertures 19a that mate with corresponding supports (not shown) extending from within the body 14 of the drone, or from the sides of the port 16. The drone antenna (not shown) may extend upwardly from the cover 18, to facilitate signal transmission between the drone 2 and its controller (not shown).

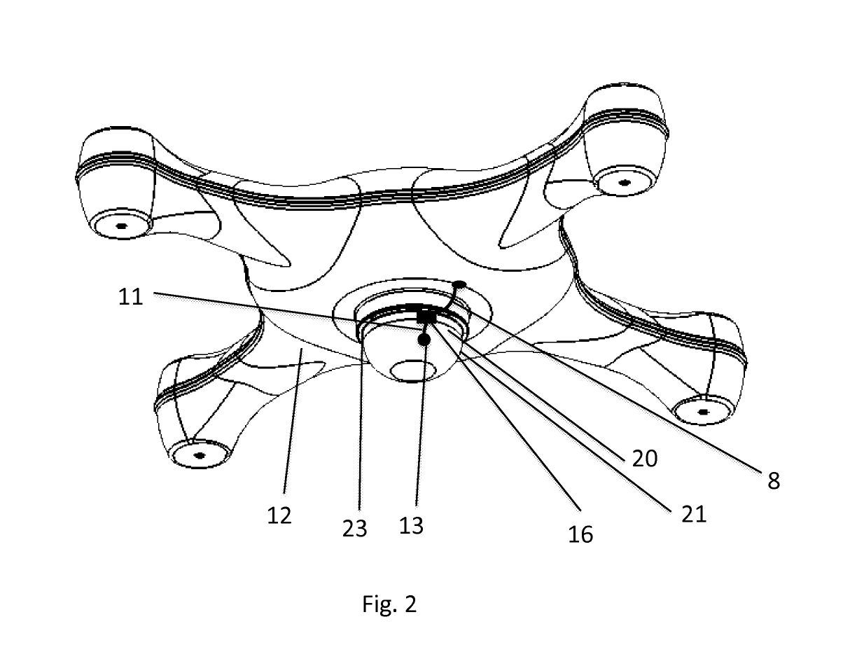

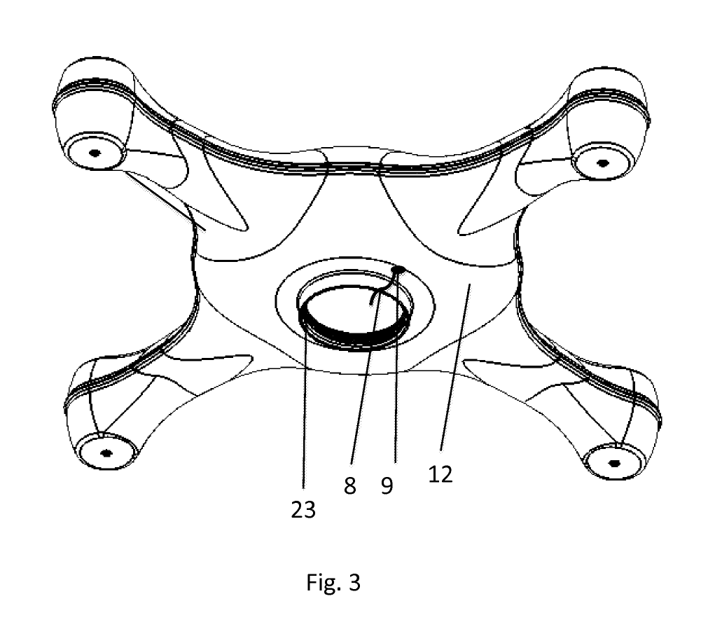

With further reference to FIGS. 2-3, fastened or molded into the lower half 13 of the drone 2 is a receptacle (not shown) for engaging with and retaining an attachment 20. The receptacle may be molded within the lower half 13, wherein the lower half is sealed and there is no access to the interior of the drone 2, or may have an aperture within the lower half to have access to the interior of the drone. In an embodiment, the receptacle 23 and attachment 20 are threaded for engagement with one another, wherein a receptacle cover 22 may be inserted into the receptacle 23 to keep the threading clean. In other embodiments the attachment 20 is removably affixed to the drone by an adhesive or by one or more bolts. The attachment 20 contains one or more peripherals within a watertight capsule. The attachment 20 may be sealed or may have a removable rear cover, or may be open to the interior of the drone 2. Preferably, the capsule is dome-shaped and molded in a single piece for water-resistance.

In one embodiment, the receptacle 23 comprises a collar 24 protruding from the lower half 13 of the drone 2. The attachment engages within the collar 24. The attachment engages with the receptacle 23 by snapping in, wherein the attachment 20 has a lip (not shown) on its upper portion for engaging within a corresponding groove (not shown) within the receptacle 23, or screwing in, wherein both the receptacle 23 and the attachment 20 have complementary threading.

In another embodiment, the receptacle comprises a bolt 26 protruding from the lower half 13 of the drone 2. The attachment has a collar that engages onto the bolt. The attachment engages with the receptacle by snapping over it, wherein the bolt has a lip on its upper portion for engaging within a corresponding groove within the attachment, or screwing in, wherein both the receptacle and the attachment have complementary threading.

The attachment 20 has an electrical connection with the drone 2 either through an external connection or a connection internal to the attachment 20 and the receptacle 23. For an external connection, a wire 11 having a fitting 16 protrudes from the attachment through an aperture in the attachment capsule 21, wherein the attachment wire aperture 13 is sealed around the wire. A corresponding wire 8 protrudes from the body 14 through a body wire aperture 9 wherein the aperture is sealed. For an internal connection, wherein the body 14 is open to the interior of the attachment 20, the wires may be connected before the attachment sealingly engages the receptacle 23. The wires may comprise power, antenna and/or data connections to provide power and data connectivity for the peripheral within the attachment 20. The wires may be connected through a number of watertight fittings 16 known in the art, for example, rubber-sealing fittings and other rubberized sealing fittings such as Molex™ connectors. For an internal connection, the wire connects the peripheral within the capsule 21 with the interior of the drone 2.

With reference to FIG. 5, in an embodiment, the attachment 20 is sealed and watertight on its own, and contains a battery for power, yet requires an antenna connection to transmit data. This is especially useful in the case of a fish finder or surveillance equipment, where real-time information is transmitted to the controller (not shown). Despite the attachment 20 being sealed, the antenna connection must connect to transmit a signal through the drone's antenna, above the cover 18, and does so by a rotatable plug 29 (similar to a headphone plug) that projects from the underside of the attachment, where it mates with the receptacle. The plug 29 meets a female jack 30 on the underside of the drone 2 in the center of the receptacle 23, such that the plug 29 is aligned and always in connection with the jack 30 as the attachment 20 is turned in engagement with the receptacle 23.

The attachment 20 may contain one or more of a number of peripherals 31. The peripheral 31 may comprise a still camera or movie camera that may be mounted within the attachment 20. In an embodiment, the attachment capsule 21 is transparent, such that the camera (not shown) is safely located within the watertight capsule 21 but may shoot images through the capsule.

A peripheral 31 may comprise a fish finder may be positioned within the attachment 20. The fish finder comprises a sonar device 31 a and is adapted to determine the location of fish within water nearby the drone. The drone lands into the water, and the attachment is submerged within the water. In an embodiment, the sonar device 31 a is in contact with the attachment so there is no air between the sonar device 31 and the capsule 21 of the attachment. The sonar works by sending out a short sound wave that may be reflected from an object such as a fish. A sonar unit may use a number of cone angles and multiple sonar beams, as may be appreciated by those skilled in the art. The fish finder may provide wireless data about the fish location through a wireless transmission from a top-mounted antenna 32 mounted on or near the receptacle cover 22.

Also for fishing, the attachment 20 may have a line catcher comprising an actuated grip 33 for holding a fishing line and delivering the line offshore, without the need for the person to enter the water. The grip 33 is remotely actuated and may drop the line when sufficiently remote from the shore, to provide the person with access to deeper waters than may be accessible from the shore. The actuated grip may be located on the bottom or the side of the sonar attachment 20. In an embodiment the grip 33 comprises a clothes' pin-type mechanism that has a spring-loaded closure, wherein the arms clamp around or below the line. A servo actuator 34 opens the arms to release the line into water below the drone. In this manner, the drone can carry lines out to 350 feet or more into the water, permitting fishermen to access deeper water without the need for a boat.

The attachment 20 may be useful for estimating or surveying in the case of construction. The drone can view inaccessible parts of a building using a camera or other observation equipment such as a heat sensor, and provide reports on damaged parts or heat loss, as the case may be. The attachment 20 may transmit data in real time and interface with a software program such as Eagleview™ aerial estimation software to improve the accuracy of estimates for contracting.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A peripheral mounting system for a drone, comprising:
a. a cylindrical receptacle configured to be mounted to the bottom of a drone;
b. an attachment for engaging with the receptacle, the attachment comprising:
i. a dome-shaped capsule configured to retain a peripheral, the edge of the capsule defining a base;
ii. a fastener at the base of the capsule, for sealingly engaging with the receptacle to form a watertight seal.

2. The peripheral mounting system of claim 1, wherein wires from the peripheral pass through an opening in the capsule to protrude from the capsule, wherein the wires and configured to connect with wires from the drone, and wherein the opening in the capsule is sealed with a sealant.

3. The peripheral mounting system of claim 1, wherein the receptacle comprises a threaded bolt protruding from the bottom of the drone, wherein the fastener is threaded onto the receptacle.

4. The peripheral mounting system of claim 1 wherein the receptacle is a threaded collar affixed to the bottom of the drone, wherein the fastener is threaded into the receptacle.

5. The peripheral mounting system of claim 1 further comprising a gasket between the receptacle and the fastener.

6. The system of claim 1 further comprising the peripheral comprising a sonar unit to locate fish and a wireless unit configured to transmit fish location to a remote user.

7. The system of claim 6 further comprising the peripheral comprising a grip configured to carry a fishing line to a remote location and an actuator for actuating the grip to release the line at the remote location.

8. An access cap for a drone, comprising:
a. a dome-shaped cap configured to fit within a drone access port, wherein the cap comprises a hollow dome made of a single piece of plastic, an opening of the dome and a port-engagement surface around the edge of the dome;
b. a gasket configured to fit between the drone access opening and the cap, and is configured to form a waterproof seal therebetween.
